(19) United States
(12) Patent Application Publication
(10) Pub. No.: US 2015/0193870 A1
(43) Pub. Date: Jul. 9, 2015

(54) GENERATING ELECTRONIC DOCUMENTS (EDOCS) FOR TRANSACTIONS

(71) Applicant: NewComLink, Inc., Austin, TX (US)

(72) Inventors: Terence Paul Spielman, Austin, TX (US); Neal Emerson Rigney, Cedar Park, TX (US); Cynthia Reh Simmons, Austin, TX (US)

(73) Assignee: NewComLink, Inc., Austin, TX (US)

(21) Appl. No.: 14/146,953

(22) Filed: Jan. 3, 2014

(51) Int. Cl. G06Q 40/02; H04L 29/06

(52) U.S. Cl. CPC G06Q 40/025; H04L 63/0435; G06Q 2220/10

(57) ABSTRACT

Some implementations include a disclosure system to receive a template and values used to fill in fields of the template. The values may include consumer information associated with a consumer. The disclosure system may receive signature data including a signature of the consumer. The disclosure system may create a disclosure that includes the template, the values, and the signature data. The disclosure system may associate a universally unique identifier with the disclosure and create, using a cryptographic hash function, a digital signature that represents the disclosure.

### BACKGROUND

Government regulations associated with consumer lending, such as the Fair Credit Reporting Act (FCRA) and the Truth in Lending Act (TILA), may include laws that regulate the collection, distribution, and use of consumer disclosures. With many financing providers in the marketplace, each financing provider may each have their own forms that reflect each financing provider's approach to complying with government regulations. For a retailer who desires to offer financing to consumers from more than one financing provider, supporting multiple financing providers, each with their own compliance approach and forms, may be cumbersome.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations may include a disclosure system to receive a template and values used to fill in fields of the template. The values may include information associated with a consumer. The disclosure system may receive signature data including a signature of the consumer. The disclosure system may create a disclosure that includes the template, the values, and the signature data. The disclosure system may associate a universally unique identifier with the disclosure and create, using a cryptographic hash function, a digital signature that represents the disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture to provide an offer for financing to a consumer according to some implementations.

FIG. 2 is an illustrative architecture to create and store a disclosure according to some implementations.

FIG. 3 is a flow diagram of an example process that includes processing a selected offer according to some implementations.

FIG. 4 is a flow diagram of an example process that includes receiving a template according to some implementations.

FIG. 5 is a flow diagram of an example process that includes creating a disclosure according to some implementations.

FIG. 6 illustrates an example configuration of a computing device and environment that can be used to implement the modules and functions described herein.

FIG. 7 is a block diagram illustrating an example of attaching additional attachments to a disclosure.

### DETAILED DESCRIPTION

The techniques and systems described herein may enable a retailer to complete a transaction between the retailer and a consumer when the consumer applies for financing by creating an electronic disclosure document to comply with various government regulations. Electronic disclosure documents may be especially useful when the retailer has multiple lenders from which to select an offer of financing for a particular consumer because documents may vary from one lender to another lender.

Retailers are interested in enabling consumers to complete transactions to purchase goods, services, or both. The transaction may include a purchase using lender provided financing, a lease to purchase, or a lease. The transaction may be associated with the purchase of goods, services, or both goods and services. Some retailers may work with a lender that provides financing to consumers. For example, if a particular retailer works with a lender that provides financing for the retailer's customers, the financing may only be used for purchases at the particular retailer. In some cases, the financing provider may manage all aspects of the financing, including determining the criteria (e.g., minimum credit score) that determines whether an applicant receives financing, processing all transactions associated with the financing, etc. However, with a single lender, if a consumer does not meet the lender's criteria, then the consumer may be denied credit and the transaction may not be completed, resulting in the retailer losing a potential sale.

One technique to avoid losing a potential sale is for the retailer to enable multiple lenders, who may have different financing criteria, to offer financing (e.g., credit card, lease to purchase, or another type of financing mechanism) to the consumer. For example, the consumer may provide consumer data (e.g., name, address, social security number) to a primary lender. The primary lender may use various criteria (e.g., credit score) to determine whether to offer financing to the consumer. If the primary lender declines to offer financing to the consumer based on the primary lender's criteria, then the retailer may provide the consumer data to one or more secondary lenders. In some cases, the primary lender may share data derived from the credit score with the secondary lenders. Each of the secondary lenders may have respective criteria. The secondary lenders may provide their respective criteria to an intermediary. The intermediary may compare the consumer data (and, in some cases, the derived data) with the criteria of the secondary lenders. If the intermediary determines that the criteria associated with a particular lender (e.g., of the secondary lenders) is satisfied, the particular lender may be selected to provide financing to the consumer. If the intermediary determines that more than one criteria of the secondary lenders is satisfied, e.g., the consumer qualifies to receive financing from more than one secondary lender, then the intermediary may select one of the secondary lenders to provide financing to the consumer. For example, an algorithm may be used to select a financing offer from one of the secondary lenders based on one or more of a maximum credit limit (e.g., a maximum that the consumer can finance at a given time), a lowest interest rate, another aspect of the credit offer, or any combination thereof. Thus, a retailer may use multiple lenders, such as primary lender(s), secondary lender(s), or both to provide an offer of financing to a consumer. By working with multiple lenders, each having their own respective financing criteria, the retailer can offer financing to more consumers, as compared to working with a single lender. Each offer of financing may be subject to various government (e.g., federal and/or state) regulations. Secondary lenders may be used by larger retailers who already have a relationship with a primary lender. Secondary lenders may also be used by smaller sized retailers who, for various reasons, may not have a relationship with a primary lender.

The techniques and systems described herein enable a retailer to complete a transaction between the retailer and a consumer when the consumer applies for financing (or prequalification for financing) by creating various electronic documents (eDocs). The eDocs may include a prequalification offer disclosure, an invitation to apply for financing, a financing application, an offer of financing (e.g., including terms and conditions), a contract to provide financing, or a charge slip. The eDocs may comply with the requirements of various government regulations, such as FCRA and TILA.

As an example of how eDocs may be used during a transaction, when a consumer is at a retailer, the consumer may be invited to apply for financing (e.g., from a primary lender) by providing consumer data. For example, the consumer data may include the consumer's name, address, employment information, social security number, and other data associated with the consumer. The consumer data may be sent by the retailer to the primary lender. If the consumer data satisfies the primary lender's criteria, the consumer may be presented with an application for financing from the primary lender. In some cases, the application for financing may be an eDoc.

If the consumer data does not satisfy the primary lender's criteria, the primary lender may indicate to the retailer (e.g., to the retailer's point of sale (POS) terminal) that the primary lender declines to provide financing. The primary lender may provide the consumer data to the retailer along with data derived from the primary lender's criteria. For example, the primary lender may determine one or more credit scores associated with the consumer based on the consumer data and the primary lender may provide derived data that identifies a range within which each credit score falls. For example, the derived data may indicate whether the consumer's credit score is in a first range (e.g., 850 to 751), in a second range (e.g., 750 to 651), or in a third range (650 or below). In response to receiving the indication that the primary lender declines to provide financing, the retailer may provide the consumer data and the derived data to an intermediary. The intermediary may evaluate the consumer data and the derived data against criteria associated with secondary lenders.

If the consumer data and derived data satisfy the criteria established by more than one of the secondary lenders, an arbitration scheme may be used to select an offer from a particular secondary lender. An application (e.g., a disclosure) corresponding to the particular lender may be created and presented to the consumer. The application presented to the consumer may be pre-filled based on the consumer data that the consumer had previously provided. In some cases, the application may request additional information and the consumer may provide additional consumer data to fill in the application. The filled in application is referred to herein as a disclosure.

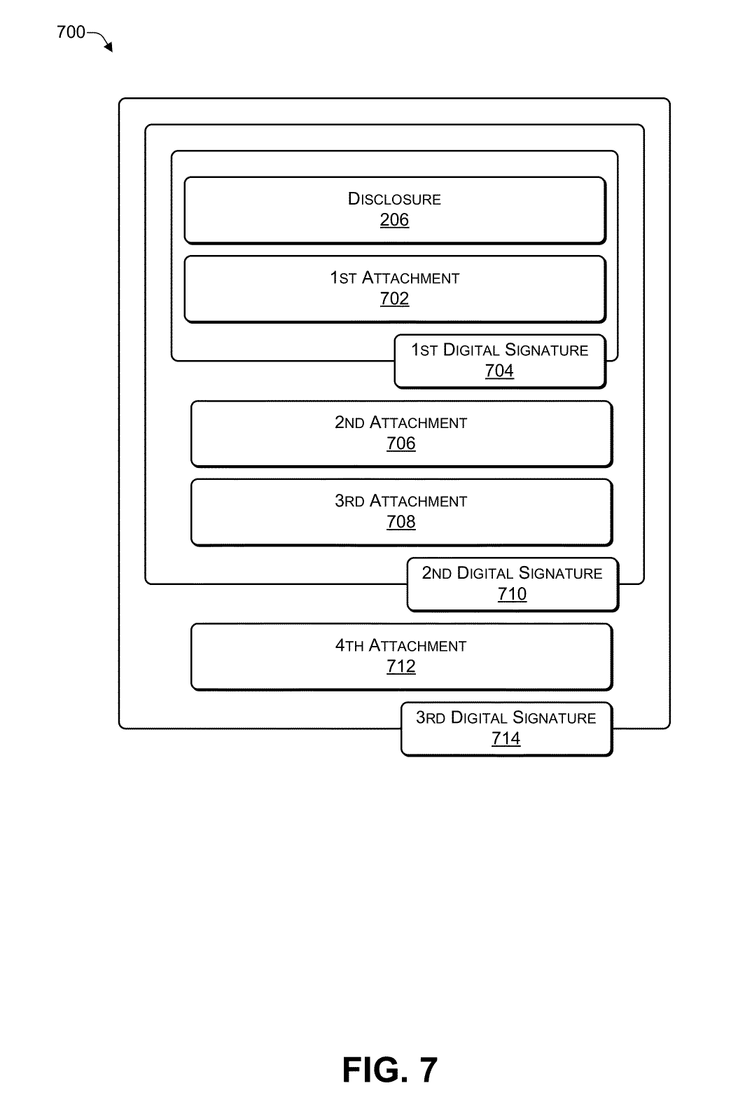

The consumer may provide a signature to the disclosure to create a signed disclosure. The signature may be captured electronically as an image file. For example, the consumer's signature may be captured when the consumer uses a stylus to provide a signature on a touch sensitive pad. As another example, the disclosure may be printed, the consumer may sign the printed disclosure, and an image of at least a portion of the signed and printed disclosure may be created (e.g., by scanning at least a portion of the signed and printed disclosure). After the consumer's signature has been captured, the disclosure may become unalterable. Unalterable means that the disclosure cannot be modified in any way, except to add new attachments, as described in more detail in FIG. 7. For example, the terms and conditions of the disclosure, the consumer's signature, and other portions of the disclosure may not be modified. Any modifications to the disclosure would indicate that the modified disclosure was not the disclosure that was originally signed by the consumer. By making the disclosure unalterable, the disclosure may comply with the definition of a transferrable record in the E-SIGN ACT of 2000. The disclosure, together with the consumer's signature, may satisfy the government requirements (e.g., TILA, FCRA, etc.) for a legal disclosure. A cryptographic hash function may take as input (i) the electronic data representing the disclosure and (ii) the electronic data representing the signature to create a hash value, known as a digital signature (DSIG). For example, a message-digest algorithm, such as MD5 or other cryptographic hash function, may be used. A cryptographic hash function is a hash function that takes an arbitrary block of data and returns a fixed-size bit string, the cryptographic hash value, such that any (accidental or intentional) change to the data will (with a very high probability) change the hash value. The data to be encoded is called the message, and the hash value is called the message digest or simply digest. The cryptographic hash function is easy to compute the hash value for any given message, is infeasible to generate a message that has a given hash, is infeasible to modify a message without changing the hash, and is infeasible to find two different messages with the same hash. The cryptographic hash function may produce a 128-bit (16-byte) hash value, which may be expressed as a 32 digit hexadecimal number.

The signature may be attached to the disclosure and saved to a database (or other computer-readable media). The attached signature may be assigned a universally unique identifier (UUID). The UUID is a standardized identifier used to enable distributed systems (e.g., systems in which data may be stored on multiple servers) to uniquely identify information without central coordination. The UUID assigned to a signature that is attached to a disclosure may be used to uniquely identify the signature attachment. In terms of the system and techniques described herein, each UUID is to be considered as uniquely identifying a particular attachment to a disclosure. In the case of two (or more) consumers signing the disclosure, each consumer's signature may be assigned a UUID and attached to the disclosure. For example, when a husband and a wife each sign a disclosure, the husband's signature may be assigned a first UUID and attached as a first attachment to the disclosure and the wife's signature may be assigned a second UUID and attached as a second attachment to the disclosure.

The legal disclosure may be recreated using a template identifier or the template that was used to create the disclosure, the fields used, the attachments, the UUID of the signature, and the DSIG. The recreated signed disclosure is verifiable as the disclosure that the consumer originally signed. For unsigned disclosures, the original disclosure may be similarly recreated except for the signature. The templates, the disclosures, and the DSIG may be stored on separate servers to provide added security. For example, even if one of the servers is breached (e.g., subject to unauthorized access), the signed disclosure may not be recreated because not all the information used to recreate the signed disclosure is stored in a single location.

Thus, a retailer that enables multiple lenders (e.g., including primary lenders, secondary lenders, or both) to provide an offer of financing to a consumer may use electronic templates, in which each lender has a corresponding set of one or more templates. For example, the set of templates corresponding to a particular lender may include a specific template for a specific geographic area (e.g., a state or a set of states) to comply with both Federal and State regulations. To illustrate, the set of templates associated with each lender of the multiple lenders may include a TX_template for the State of Texas, a WA_template for the State of Washington, etc.

After a consumer applies to be prequalified for financing, multiple lenders (e.g., primary lender(s), secondary lender(s), or both) may determine whether to invite the consumer to apply for financing. A corresponding eDoc template may be selected, assigned a UUID to create a disclosure, and presented to the consumer or to an agent of the retailer. Consumer data (e.g., name, address, social security number, and the like) may be provided to fill in the fields of the template to create an unsigned disclosure. The consumer may sign the disclosure and the signature may be captured electronically. For example, the consumer's signature may be captured when the consumer uses a stylus to sign a touch-sensitive pad. As another example, the unsigned disclosure may be printed out, the consumer may sign the printed disclosure to create a signed disclosure, and at least a portion of the signed disclosure may be electronically captured (e.g., by creating an image file of at least the portion of the signed disclosure that includes the signature). The image file may be created by scanning, faxing, taking a photograph, or other means of generating an image file. The signature may be attached to the electronic disclosure using a UUID. A cryptographic hash function may be used to create a DSIG based on (i) the electronic disclosure and (ii) the image file of the signature. The DSIG may be used to electronically represent the signed disclosure during data interchange between two or more of the retailer, the lender, the consumer, etc. The DSIG may be smaller in size as compared to the electronic disclosure and the attached signatures, enabling multiple DSIGs to be interchanged using less bandwidth as compared to sending and receiving multiple disclosures and the corresponding attachments. In addition, the use of a cryptographic hash function to create the DSIG may provide security, such that if the DSIG is accessed by an unauthorized party, the consumer data cannot be retrieved from the DSIG. Thus, the DSIG may electronically represent the signed disclosure but in a relatively smaller size and enable the DSIG to be securely transmitted over unsecured networks. Using electronic disclosures for creating, storing, and transmitting signed disclosures may be less time consuming, cheaper, faster, and more efficient as compared to using alternatives, such as paper documents.

### Illustrative Architectures

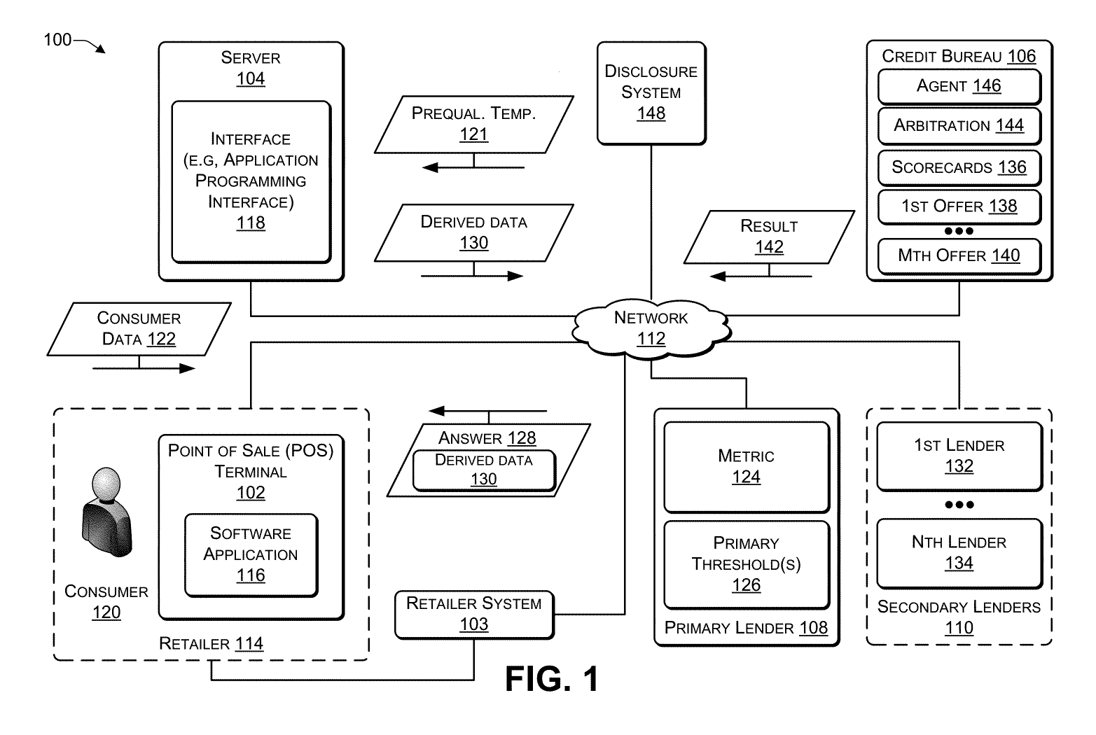

FIG. 1 is an illustrative architecture 100 to provide an offer for financing to a consumer according to some implementations. The architecture 100 includes a representative point of sale (POS) terminal 102, a retailer system 103, a server 104, a credit bureau 106, at least one primary lender 108, and one or more secondary lenders 110 communicatively coupled to a network 112. The network 112 may include one or more networks, such as a wireless local area network (e.g., WiFi, Bluetooth™, or other type of near-field communication (NFC) network), a wireless wide area network (e.g., a code division multiple access (CDMA) network, a global system for mobile (GSM) network, or a long term evolution (LTE) network), a wired network (e.g., Ethernet, data over cable service interface specification (DOCSIS), Fiber Optic System (FiOS), Digital Subscriber Line (DSL) and the like), other types of networks, or any combination thereof. The POS terminal 102 and the server 104 may each comprise a computer-based device that includes one or more processors and one or more computer-readable media to store instructions that are executable by the one or more processors to perform various functions as described herein.

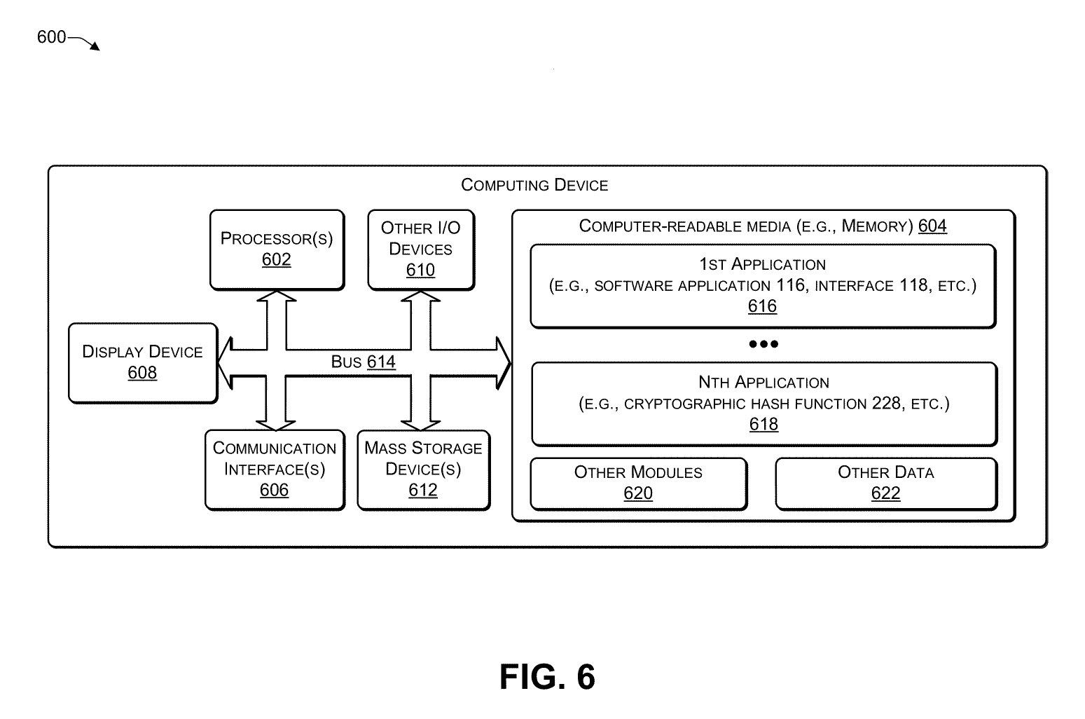

The representative POS terminal 102 may be located at a location of a retailer 114. While a single POS terminal is illustrated in FIG. 1, the retailer 114 may have more than POS terminal at each location. In addition, the retailer 114 may have more than one location. For example, the retailer 114 may have multiple locations that are geographically dispersed and each of the multiple locations may have one or more POS terminals. The POS terminal 102 may be a computing device (e.g., as described in more detail in FIG. 6) with one or more processors, one or more input devices (e.g., keyboard, mouse, credit card scanner, touch-sensitive pad, etc.) and one or more computer-readable media. The computer-readable media may be used to store an operating system, device drivers, and one or more software applications, such as a representative software application 116. The software application 116 may communicate directly (e.g., using the network 112) with one or more of the credit bureau 106, the primary lender 108, or the secondary lenders 110. The software application 116 may communicate with one or more of the credit bureau 106, the primary lender 108, or the secondary lenders 110 using an interface 118 that is hosted by the server 104. For example, the interface 118 may be an application programming interface (API) or other type of software interface that can be called by the software application 116 of the POS terminal 102 to access one or more of the credit bureau 106, the primary lender 108, or the secondary lenders 110. The retailer 114 may be a “bricks and mortar” retailer with a physical presence or the retailer 114 may be a network-based retailer that provides a catalog of products and/or services for purchase via the interface 118 hosted by the server 104.

The POS terminal 102 may be electronically coupled to a retailer system 103. For example, each POS terminal of the retailer 114 may communicate with the retailer system 103. In some implementations, the POS terminal 102 may communicate with the retailer system 103, and the retailer system 103 may communicate with the interface 118, a disclosure system 148 (described further below), or both. For example, the POS terminal 102 may send a message to the retailer system 103, the retailer system 103 may send the message to the interface 118 (or the disclosure system 148), the retailer system 103 may receive a response from the interface 118 (or the disclosure system 148), and the retailer system 103 may send the response to the POS terminal 102. For ease of discussion, the various examples herein may describe the POS terminal 102 as sending or receiving various data items; however it should be understood that at least a portion of these communications may take place through the retailer system 103.

In the following examples, the POS terminal 102 is described as sending or receiving various data items. However, it is to be understood that in some implementations, the POS terminal 102 may communicate with the interface 118 to send or receive the data items. For example, the interface 118 may be a website hosted by the server 104 which is accessed by the POS terminal 102.

A consumer 120 may desire to initiate a transaction (e.g., to purchase, lease, or lease purchase) one or more items (e.g., goods, services, or both goods and services) from the retailer 114. The consumer 120 may desire to finance at least a portion of the transaction. The consumer 120 may inquire whether financing is available to complete the consumer's transaction or an agent (e.g., salesclerk) of the retailer 114 may inform the consumer 102 that financing may be available. In response to the consumer 120 indicating a desire to be prequalified, the POS terminal 102 (or the interface 118) may send a prequalification template request to the disclosure system 148. In response to receiving the prequalification template request, a prequalification template 121 (denoted “prequal. temp.” in FIG. 1) may be retrieved by the disclosure system 148 and sent to the POS terminal 102. The prequalification template 121 may be presented to the consumer 102. The prequalification template 121 may be a type of disclosure used by the primary lender 108. In response, the consumer 120 may provide consumer data 122 to the primary lender 108. For example, the consumer data 122 may be provided to fill in the fields of the prequalification template 121.

The consumer data 122 may include data associated with the consumer 120, such as a name and address of the consumer, a social security number of the consumer, employment information (e.g., name and address of employer, length of employment, salary, etc.), assets (e.g., investments), liabilities (e.g., mortgage, car loan, etc.), past credit history, length of credit history, repayment history, and other information used by a lender to determine whether to provide financing to the consumer 120.

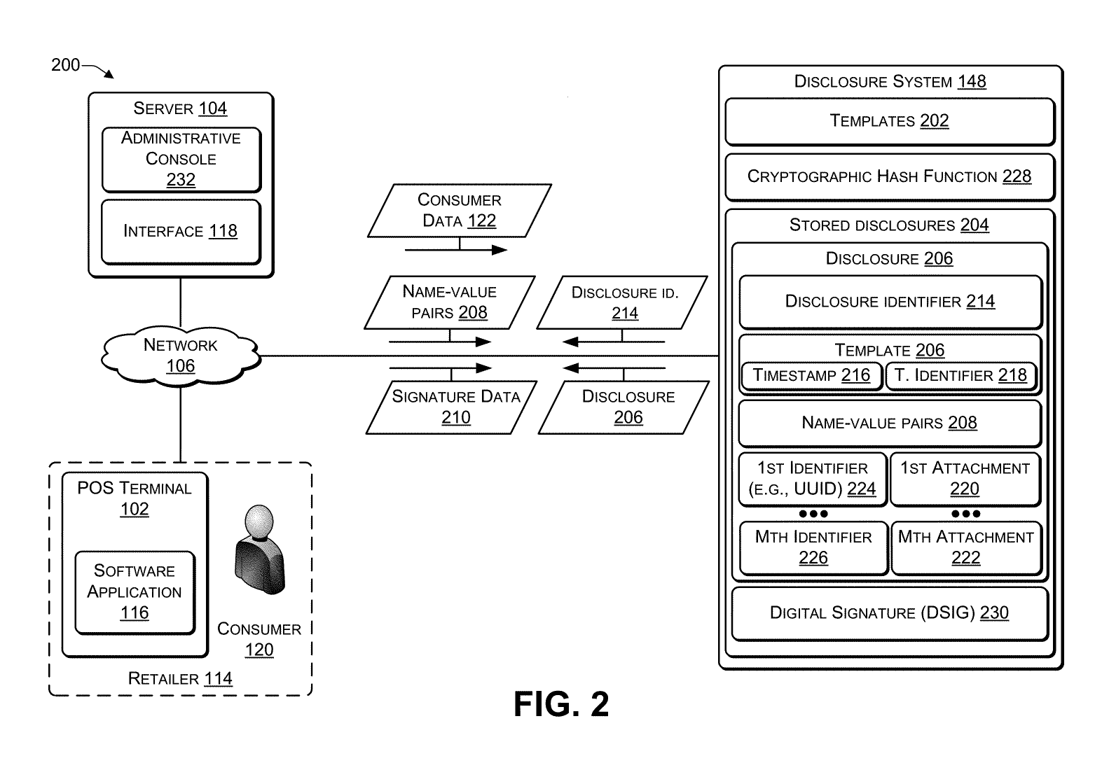

The consumer data 122 may be sent from the POS terminal 102 (or using the interface 118) to a representative primary lender 108. While one primary lender is illustrated in FIG. 1, in some implementations, more than one primary lender may be used. The primary lender 108 may determine a metric 124, such as a FICO score or other similar metric, based on the consumer data 122. For example, the primary lender 108 may determine the metric 124 using a consumer reporting agency, such as Equifax®, Experian®, TransUnion®, or other agency. The primary lender 108 may compare the metric 124 and the consumer data 122 with criteria, such as one or more primary thresholds 126. For example, the primary thresholds 126 may specify various criteria that the primary lender 108 uses to determine whether to invite the consumer 120 to apply for financing, such as length of employment criteria, salary criteria, asset criteria, liability criteria, past credit history criteria, length of credit history criteria, repayment history criteria, etc. If the metric 124 and the consumer data 122 satisfy (e.g., are greater than or equal to) the primary thresholds 126, then the primary lender 108 may provide an answer 128 that includes an invitation to apply for financing to the consumer 120. In response to determining that the answer 128 includes an invitation to apply for financing to the consumer 120, the POS terminal 102 may initiate providing an appropriate eDOC (e.g., lender-specific disclosure), as discussed in more detail in FIG. 2.

If one or more of the metric 124 or the consumer data 122 do not satisfy (e.g., are less than) the criteria (e.g., the primary thresholds 126), then the primary lender 108 may provide the answer 128 indicating that the primary lender 108 declines to provide an invitation to apply for financing to the consumer. The answer 128 may include the metric 124, the consumer data 122, derived data 130 that was derived from the metric 124, or any combination thereof. In some cases, the derived data 130 may specify a particular range within which the metric 124 falls. For example, when the metric 124 is between A and B (where A and B are integers and A is not equal to B), the derived data 130 may indicate that the metric 124 is within a first band, when the metric 124 is between B and C, the derived data 130 may indicate that the metric 124 is within a second range, etc. To illustrate, when the metric 124 is between 800 and 750, the derived data 130 may indicate that the metric 124 falls within a first range, when the metric 124 is between 749 and 700, the derived data 130 may indicate that the metric 124 falls within a second range, and so on.

In response to determining that the answer 128 indicates that the primary lender 108 has declined to provide an invitation to apply for financing to the consumer 120, the POS terminal 102 (or the interface 118) may automatically (e.g., without human interaction) retrieve the derived data 130 from the answer 128 and automatically send the derived data 130 and the consumer data 122 to the credit bureau 106 via an intermediary, such as the server 104. Because the POS terminal 102 automatically sends the derived data 130 and the consumer data 122 to the credit bureau 106, the consumer 120 may be unaware that the primary lender 108 declined to provide an invitation to apply for financing.

The credit bureau 106 may use the consumer data 122, the derived data 130, or both to determine whether to provide an invitation to apply for financing from one of the secondary lenders 110. The secondary lenders 110 may include one or more secondary lenders. In FIG. 1, N lenders, such as a first lender 132 to an Nth lender 134 (where N>1), are illustrated. Each of the secondary lenders 132 to 134 may have a corresponding scorecard (e.g., a scoring algorithm and criteria) which the credit bureau 106 uses to determine whether to provide an offer of financing to the consumer 120. In this example, scorecards 136 may include N scorecards corresponding to each of the N lenders 132 to 134. Each of the N scorecards 136 may include criteria provided by each of the N lenders 132 to 134. For example, each of the scorecards 136 may include weights for different portions of the consumer data 122 and for the derived data 130. The scoring algorithm may apply the weights to the consumer data 122 and the derived data 130, compare the weighted consumer data 122 and the weighted derived data 130 with lender specific criteria (e.g., thresholds), and determine whether the consumer 120 qualifies for financing (or qualifies for an invitation to apply for financing) from one or more of the secondary lenders 110.

The credit bureau 106 may use the scorecards 136 (e.g., scoring algorithms and criteria) to determine whether to provide an invitation to apply for financing. The scorecards 136 may include criteria, such as criteria for the metric 124, length of employment criteria, salary criteria, asset criteria, liability criteria, past credit history criteria, length of credit history criteria, repayment history criteria, etc. The scorecards 136 may use the consumer data 122, the derived data 130, or both to determine whether to provide an invitation to apply for financing to the consumer 120. The credit bureau 106 may use the corresponding scorecards 136 to determine whether the consumer 120 qualifies for zero, one, or M offers 138 to 140 (M>0). If the consumer 120 qualifies for zero offers, a result 142 may be sent to the POS terminal 102 indicating that prequalification has been completed and no invitations to apply for financing are available. If the consumer 120 qualifies for one offer from the lenders 132 to 134, the result 142 may identify an offer (e.g., the Mth offer 140) provided by one of the lenders 132 to 134 and the consumer 120 may be invited to apply for financing from the secondary lender corresponding to the offer. If there are two or more offers (e.g., M>1), then an arbitration algorithm 144 may select from one of the offers 138 to 140. In some cases, when M>1, an agent 146 of the credit bureau 106 may select one of the offers 138 to 140 using the arbitration algorithm 144. For example, the arbitration algorithm 144 may select one of the offers 138 to 140 based on one or more factors, such as a size of the credit limit offered, an interest rate offered, a type of payment plan offered, other information associated with the offers 138 to 140, or any combination thereof.

If the result 142 (or the answer 128) includes an invitation to apply for financing from a lender (e.g., from the primary lender 108 or from one of the secondary lenders 110), the POS terminal 102 (or the interface 118) may request a disclosure (e.g., from a disclosure system) associated with the lender for the consumer 120 to complete (e.g., by signing). The disclosure may be prefilled with at least a portion of the consumer data 122. In some cases, the consumer 120 may provide additional consumer data to fill in at least a portion of the disclosure. For example, the consumer data 122 may correspond to criteria (e.g., the primary thresholds 126) used by the primary lender 108 and at least one of the secondary lenders 110 may have additional criteria. To illustrate, one of the secondary lenders 110 may lend to those with past military service. In this example, the template used by the second lender may request additional consumer data related to the military service of the consumer 120. As another example, a secondary lender may lend to consumers with credit scores in a lower range compared to the primary lender 108. The secondary lender may request additional employment history information as compared to the primary lender 108. For example, the primary lender 108 may request two years of employment history while the secondary lender may request five years of employment history.

The disclosure associated with a particular offer may be created using the disclosure system 148. The disclosure system 148 may include templates associated with each lender that may be used to create a disclosure for the consumer 120. A digital representation of the signed disclosure may be stored by the disclosure system 148. The disclosure system 148 may comprise a computer-based device that includes one or more processors and one or more computer-readable media storing instructions that are executable by the one or more processors to perform various functions. The disclosure system 148 is described in more detail in FIG. 2. A template may specify (1) information associated with the lender that is making the offer of financing (or providing an invitation to apply for credit), (2) terms and conditions associated with the lender's financing, (3) information associated with the retailer, and other information related to a consumer financing disclosure.

Thus, the consumer 120 may provide information (e.g., consumer data 122) when invited to apply for financing from one or more primary lenders (e.g., the primary lender 108). If the consumer 120 does not receive an offer of financing from the primary lenders, the information may be provided to one or more secondary lenders 110. If the secondary lenders 110 provide more than one offer, one of the offers may be selected using an arbitration scheme (e.g., arbitration 144). In this way, instead of just one lender, multiple lenders may be used to select an offer of financing to be provided to the consumer 120.

FIG. 2 is an illustrative architecture 200 to create and store a disclosure according to some implementations. The architecture 200 illustrates how, after an invitation to apply for financing has been selected from one of multiple lenders, a legally-binding disclosure that complies with applicable laws (e.g., TILA, FCRA, etc.) may be created, stored, retrieved, and recreated. The architecture 200 may use a variety of database technologies, including one or more of a not only structured query language (NoSQL) database, a relational database, a non-relational database, etc. A NoSQL database may use a mechanism for storage and retrieval of data that is different from mechanisms used in relational databases to enable a simpler design, horizontal scaling, and finer control over availability. A NoSQL database may enable SQL-like query languages to be used.

The disclosure system 148 may include one or more templates 202 and one or more stored disclosures 204. For example, each lender (e.g., from the lenders 108 and 110 of FIG. 1) may have a corresponding set of templates in the templates 202. To illustrate, the primary lender 108 may have a corresponding set of templates in the templates 202, the first lender 132 of the secondary lenders 110 may have a corresponding set of templates in the templates 202, and the Nth lender 134 of the secondary lenders 110 may have a corresponding Nth set of templates in the templates 202. Each template may be tailored to a specific retailer, specific laws, and/or specific types of consumers. For example, a particular template may comply with both applicable Federal and state laws and be used with the retailer 114. As another example, a first template may be used for active military personnel, a second template may be used for non-active (e.g., former) military personnel, and a third template may be used for people who have never served in the military.

When a consumer qualifies for financing, a template may be selected, the template created, and the created template assigned an identifier (e.g., UUID) to create a disclosure 206. After the disclosure 206 is created, the consumer 120 may sign the disclosure 206 to create a signed disclosure. A digital representation of the signed disclosure may be stored by the disclosure system 148 as one of the stored disclosures 204. The templates 202 and stored disclosures 204 may include invitations to apply for financing, applications for credit, and any other forms used by the lenders during a transaction.

At least some of the templates 202 may have an associated expiry date. For example, if a new law or regulation is scheduled to take effect on a particular date, a first template may be used prior to the particular date. After the particular date, the first template may be considered to have expired and a second template may be used instead of the first template. Even if a template is expired, the template may be kept in the disclosure system 148 if one or more of the stored disclosures 204 use the expired template. The disclosure system 148 may enable templates and disclosures to be CReated, Updated, or Deleted (CRUD).

After a lender (e.g., one of the primary lender 108 or the secondary lenders 110) has determined that the consumer 120 is credit worthy based on the consumer data 122, the consumer 120 may be presented with an application for financing from the lender. For example, the POS terminal 102 (or the interface 118) may receive the disclosure 206 from the disclosure system 148. The disclosure 206 may be created based on one of the templates 202.

The disclosure 206 may include an application for financing that is presented to the consumer 120 and may be tailored for the lender that made the offer and tailored based on one or more characteristics of the consumer 120. The disclosure 206 may include information identifying the lender, the retailer 114, a version of the template used to create the disclosure 206, etc. In some implementations, the POS terminal 102 (or the interface 118) may request the disclosure 206 from the disclosure system 148, while in other implementations the disclosure system 148 may automatically send the disclosure 206 to the POS terminal 102 after a lender has determined to provide an offer to the consumer 120. For example, the POS terminal 102 (or the interface 118) may send a request using HyperText Transfer Protocol (HTTP), eXtended Markup Language (XML), JavaScript Object Notation (JSON), another type of request protocol, or any combination thereof.

The POS terminal 102 may specify a format for the disclosure 206 and the disclosure system 148 may create the disclosure 206 in the specified format. The POS terminal 102 may specify a format for the disclosure 206 that the POS terminal 102 is capable of presenting to the consumer 120. The presentation of the disclosure 206 may be compliant with the Americans with Disabilities Act (ADA). For example, the disclosure 206 may be presented to the consumer 120 by displaying the disclosure 206 on a display device, by printing the disclosure 206, by playing back an audio file, etc. The disclosure 206 may be implemented using a variety of formats, including HyperText Markup Language (HTML), extended markup language (XML), Portable Document Format (PDF), text, audio file (e.g., for presenting to legally blind consumers), another format, or any combination thereof. In some cases, the POS terminal 102 or the interface 118 may provide text-to-speech, text-to-Braille, or other capabilities to accommodate consumers with disabilities.

In some cases, the interface 118 may include multiple interfaces. For example, the interface 118 may include a template interface (e.g., API) to access the templates 202 and a disclosure interface to access the stored disclosures 204.

The consumer 120 or an agent (e.g., salesclerk) of the retailer 114 may obtain consumer data corresponding to the different fields of the disclosure 206. The consumer data along with the fields of the disclosure 206 may be referred to as name-value pairs 208. For example, the disclosure 206 may include multiple field names and the consumer 120 may provide multiple values to be filled in to (e.g., associated with) each of the multiple field names. To illustrate, a field name “employer-related information” may be associated with values such as an employment history, a current employer name, how long the consumer 120 has been employed, salary information, and other employer-related information of the consumer 120. A field name “personal information” may be associated with values that include a current address, a past address, etc. A field name “financial information” may be associated with values such as liabilities and assets of the consumer 120. The name-value pairs 208 may include system-derived information, such as algorithmic instructions. An example of an algorithimic instructions may be:

if [field A>50] then “large value loan” else “regular loan.”

After the fields of the disclosure 206 are filled in with information associated with the consumer 120, the consumer 120 may sign the filled-in template. In some cases, the consumer 120 may use a stylus on a touch-sensitive pad (e.g., on the POS terminal 102) to create signature data 210 that includes data that electronically captures a signature of the consumer 120. The electronic capture of a signature using a touch-sensitive pad may be referred to as an electronic signature or esig. In other cases, the disclosure 206 that is filled with information associated with the consumer 120 may be printed to create a hard copy disclosure that the consumer 120 signs using a writing instrument, such as a pen. At least a portion of the signed and printed document that includes the signature may be digitally captured to create the signature data 210. For example, the signature data 210 may be created by scanning, faxing, or other means of capturing an image of at least a portion of the signed and printed document that includes the signature. Once the signature data 210 is created, the disclosure 206 with the name-value pairs 208 and the signature data 210 may become unalterable (e.g., such that the disclosure 206 complies with the transferrable record requirements of the E-SIGN Act of 2000) and may be stored in the disclosure system 148 as disclosure 206.

The stored disclosures 204 may be used to store multiple disclosures (signed or unsigned), such as the representative disclosure 206. The disclosure 206 may include a disclosure identifier 214 that uniquely identifies the disclosure 206 from other disclosures and/or templates stored in the disclosure system 148. When a lender has been identified to provide a financing offer to the consumer 120, an administrative console 232 or the disclosure system 148 may select one of the templates 202 based on the lender, the retailer 114, a geographic location of the retailer 114, another factor, or any combination thereof. The administrative console 232 or the disclosure system 148 may create a disclosure (e.g., the disclosure 206) for a particular consumer (e.g., the consumer 120), and assign an identifier (e.g., the disclosure identifier 214) to the disclosure. For example, the disclosure identifier 214 may be a UUID or similar unique identifier. The representative disclosure 206 may include the disclosure 206. The disclosure 206 may include a timestamp 216 and a template identifier 218 (denoted as “T. Identifier” in FIG. 2). The timestamp 216 may include date information, time information, or both indicating when the disclosure 206 was generated or sent to the POS terminal 102. The template identifier 218 may uniquely identify (e.g., using a UUID) the disclosure 206 from other templates in the templates 202. The disclosure 206 may include the name-value pairs 208, including the information provided by the consumer 120 to fill in the disclosure 206.

Each of the stored disclosures 204 may include zero or more attachments. As an illustrative example, the disclosure 206 in FIG. 2 is illustrated as having M attachments (where M>1), including a first attachment 220 to an Mth attachment 222. The attachments 220 to 222 may include digital image data, such as the signature data 210, image data of associated documentation (e.g., the printed disclosure that initialed on each page and signed on the signature page by the consumer 120), image data associated with identification (e.g., driver's license, military identifier, passport, etc.), image data of an image of the customer, other digital image data related to the disclosure 206, or any combination thereof. Each of the attachments 220 to 222 may have a corresponding attachment identifier. For example, the first attachment 220 may be associated with a corresponding first attachment identifier 224 and the Mth attachment 222 may be associated with an Mth attachment identifier 226. The attachment identifiers 224 to 226 may be implemented using a UUID or other similar unique identifier.

The stored disclosures 204 may each include additional information, such as information identifying (i) a lender associated with the disclosure (e.g., the lender making the offer of financing), (ii) a retailer associated with the disclosure (e.g., “XYZ Jewelry”), (iii) a store number associated with the disclosure (e.g., “Store #1234”), (iv) a transaction type (e.g., purchase, lease, lease to purchase, etc.), (v) a step in the transaction process (e.g., disclosure created but not signed, signed disclosure, etc.).

The disclosure system 148 may use a cryptographic hash function 228 to create a digital signature (DSIG) for each of the signed disclosures stored in the stored disclosures 204. For example, the cryptographic hash function 228 may be used to create the DSIG 230 based on the disclosure 206. The cryptographic hash function 228 may produce a 128-bit (16-byte), 160-bit or 256-bit hash value, typically expressed as a 32 digit hexadecimal number. The cryptographic hash function 228 may be based on a message-digest algorithm or secure hash algorithm 1 (SHA-1). The DSIG 230 enables the printed and signed disclosure to be discarded because the printed and signed disclosure may be validated or recreated based on the DSIG 230 and the disclosure 206. The DSIG 230 may provide a secure way of referencing the printed and signed disclosure. The DSIG 230 may be securely transmitted because of the cryptographic hash function used to create the DSIG 230. An unauthorized party that accesses the DSIG 230 would be unable to retrieve information associated with the consumer 120 or the disclosure 206 due to the cryptographic encryption. In addition, the DSIG 230 may be smaller in size relative to the disclosure 206. The disclosure system 148 may reduce bandwidth usage by using the DSIG 230 to reference the disclosure 206 instead of using the disclosure 206 itself.

In some implementations, the administrative console 232 may be used to create, update, and delete the templates 202 and the stored disclosures 204. The administrative console 232 may be hosted by the server 104 or may be a standalone device. For example, the administrative console 232 may be implemented as a web page hosted by the server 104.

One or more of the software application 116, the POS terminal 102, or the interface 118 may communicate with the disclosure system 148 to retrieve (or request) the disclosure 206, to send the name-value pairs 208, and to perform the other actions described herein. For example, the POS terminal 102 may navigate to a website hosted by the server 104 to access the interface 118 to access the disclosure 206. The communication between the software application 116, the POS terminal 102, or the interface 118 and the disclosure system 148 may be performed using one or more protocols, such as eXtended Markup Language (XML), HyperText Transfer Protocol (HTTP), HyperText Markup Language (HTML), Java Script, Java Script Object Notation (JSON), another protocol, or any combination thereof.

Various operations may be communicated to the disclosure system 148. For example, the operations may include GET, POST, PUT, DEL, HEAD, and POST. A GET operation may be used to retrieve a document (e.g., template or disclosure) from the disclosure system 148. A POST operation may be used to update contents of a document (e.g., template or disclosure) stored in the disclosure system 148. A PUT operation may be used to create a document (e.g., template or disclosure) in the disclosure system 148. A HEAD operation may be used to retrieve properties associated with a document (e.g., template or disclosure) in the disclosure system 148. For example, the properties associated with a document may include a date that the document was created, a date that the document was updated, a version, a retailer with which the template is associated, a lender with which the template is associated, etc. A DEL operation may be used to delete (e.g., remove) a document (e.g., template or disclosure) from the disclosure system 148. At least some of the operations (e.g., GET, PUT, and HEAD) may be idempotent. An idempotent is an operation that may be applied multiple times without changing the result beyond the initial application. An operation is idempotent if, whenever it is applied twice to any value, it gives the same result as if it were applied once; i.e., f(f(x))=f(x). For example, absolute value of a number, the larger of two different numbers, or multiplication by “1” are all idempotent operations.

The GET operation may take zero or more parameters that specify properties associated with the document that is to be retrieved by the GET operation. For example, “GET <retailer name> <lender name> <version> <date created>” may initiate a search for documents in the disclosure system 148 that are associated with the specified retailer name, the specified lender name, the specified version, and the specified date when the document was created. For example, to retrieve documents associated with retailer ABC, lender XYZ, version 2 (e.g., V2), created on Oct. 10, 2012, the POS terminal 102 (or the interface 118) may send “GET ABC XYZ V2 10-10-2012.” If no documents match the specified properties, then the disclosure system 148 may automatically remove one of the supplied parameters and perform another search. The disclosure system 148 may repeatedly remove one of the supplied parameters and perform another search until at least one document is found during the search. If all the supplied parameters are removed, a default template may be provided as the result of the search. Referring to the previous example, if no documents match the specified parameters (e.g., <retailer name>, <lender name>, <version>, and <date created>), then the date created property may be removed and “GET <retailer name> <lender name> <version>” may initiate a search for documents in the disclosure system 148 that are associated with the specified retailer name, the specified lender name, and the specified version. If no documents match the specified parameters (e.g., <retailer name>, <lender name>, and <version>), then the version property may be removed and “GET <retailer name> <lender name>” may initiate a search for documents in the disclosure system 148 that are associated with the specified retailer name and the specified lender name. If no documents match the specified parameters (e.g., <retailer name> and <lender name>), then the lender name property may be removed and “GET <retailer name>” may initiate a search for documents in the disclosure system 148 that are associated with the specified retailer name. If no documents match the specified parameters (e.g., <retailer name>), then the retailer name property may be removed and “GET” may initiate a search that returns a default document (e.g., a default template). Of course, the order in which the parameters are specified and how many parameters may be specified may vary depending on the specific implementation.

The disclosure system 148 may include multiple computing devices (e.g., servers) and the contents of the disclosure system 148 may be distributed across the multiple computing devices. For example, a first server may store the templates 202 and a second server may store the stored disclosures 204. In some cases, the attachments for each of the stored disclosures 204 may be stored on a third server. For example, the attachments 220 to 222 may be stored on a third server that is different from a second server that is used to store the disclosure 206. In this example, the disclosure 206 may include an address (e.g., a pointer) to the attachments 220 to 222 that are stored on the third server. The DSIG 230 enables the original disclosure to be recreated and validated. For example, the DSIG 230 may be used to verify (i) that the disclosure 206 was presented to the consumer 120, (ii) what information was in the template 208 that was presented to the consumer 120, and (iii) what document was signed by the consumer 120.

When a lender has been identified to provide a financing offer to the consumer 120, the POS terminal 102 may request that a disclosure be created. In response, the administrative console 232 (or the disclosure system 148) may select one of the templates 202. The administrative console 232 (or the disclosure system 148) may create a disclosure (e.g., the disclosure 206) for a particular consumer (e.g., the consumer 120), and assign an identifier (e.g., the disclosure identifier 214) to the disclosure. In response to receiving the request from the POS terminal 102 to create the disclosure 206, the administrative console 232 (or the disclosure system 148) may provide the disclosure identifier 214 to the POS terminal 102. After receiving the disclosure identifier 214, the POS terminal 102 may send a request to the disclosure system 148 for the disclosure 206 that specifies a format of the disclosure 206. In response to the request, the disclosure system 148 may provide the disclosure 206 to the POS terminal 102 in the specified format (e.g., PDF, text, audio file, etc.).

Thus, a disclosure may be created, assigned an identifier, and presented to a consumer at a POS terminal. The disclosure may be at least partially populated with consumer data. The consumer may provide additional consumer data to fill in a portion of the disclosure. The consumer may provide a signature that is captured in the form of image data. Attachments, such as the signature data, may be assigned a unique identifier (e.g., UUID) and attached to the disclosure as an attachment. A digital signature (DSIG) of the signed disclosure may be created using a cryptographic hash function. The DSIG may be used to securely reference the signed disclosure, to verify the authenticity of the signed disclosure, and to recreate the signed disclosure if the signed and printed disclosure is unavailable.

### Example Processes

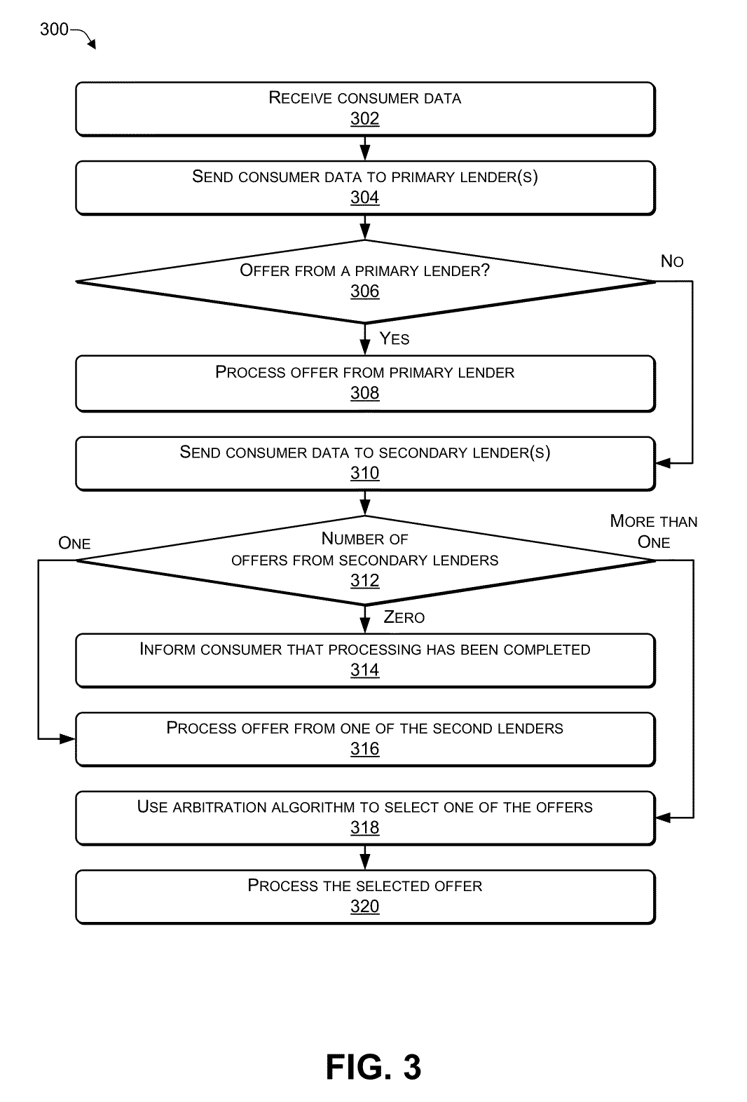

In the flow diagrams of FIGS. 3-5, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 300, 400, and 500 are described with reference to the architectures 100 and 200 as described above, although other models, frameworks, systems and environments may be used to implement these processes.

FIG. 3 is a flow diagram of an example process 300 that includes processing a selected offer according to some implementations. For example, the process 300 may be performed by the POS terminal 102, the interface 118, or a combination of the POS terminal 102 and the interface 118 of FIG. 1 or FIG. 2.

At 302, consumer data may be received. For example, in FIG. 1, the consumer 120 may provide the consumer data 122 to determine whether the consumer 120 prequalifies to be invited to apply for financing. The consumer data 122 may be created by the POS terminal 102, the interface 118, or a combination of both. The consumer data 122 may be entered into the prequalification template 121.

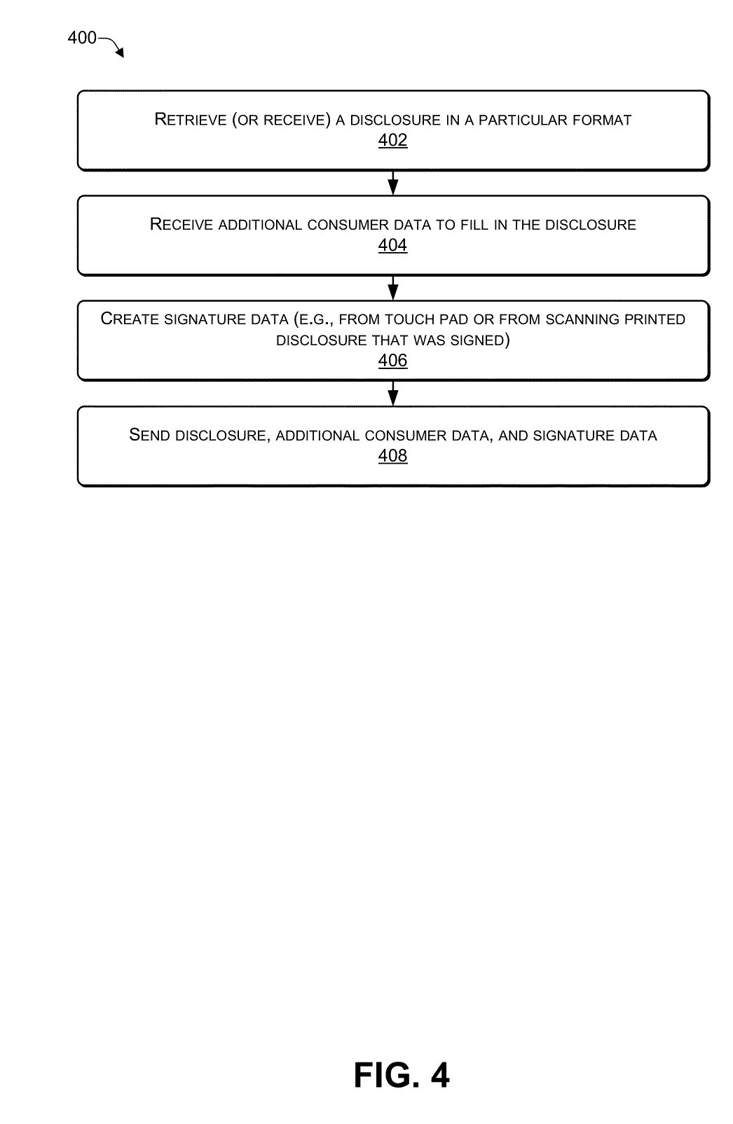

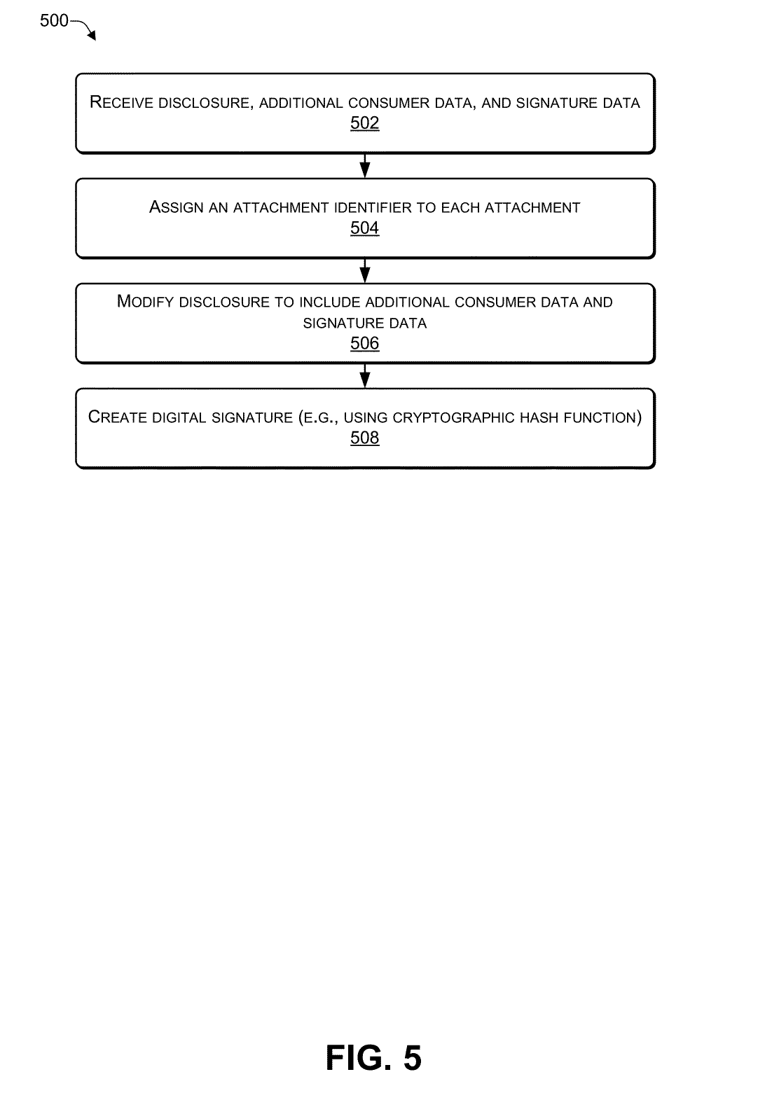

At 304, the consumer data may be sent to at least one primary lender. At 306, a determination may be made as to whether an offer (e.g., invitation) to apply for financing was received from the at least one primary lender. If a determination is made that the offer was received from a primary lender, at 306, then the offer from the primary lender to apply for financing may be processed, at 308. For example, in FIG. 1, the consumer data 122 may be sent to the primary lender 108. If the answer 128 indicates that the primary lender 108 is inviting the consumer 120 to apply for financing, then the offer may be processed, e.g., by retrieving a corresponding template, presenting the template to the consumer, and receiving the consumer's signature. Processing an offer from a lender is described in more detail in FIG. 4 and FIG. 5.

If a determination is made that no offer to apply for financing was received from the primary lender, at 306, then the consumer data may be sent to one or more secondary lenders, at 310. For example, if the answer 128 indicates that the primary lender 108 has declined to provide an offer to apply for financing, the consumer data 122 may be sent to the credit bureau 106 to determine whether any of the secondary lenders 110 may provide an offer to apply for financing. In some cases, the derived data 130 may be sent along with the consumer data 122 to the credit bureau 106 and/or the secondary lenders 110. For example, the derived data may identify a range within which the metric 124 (e.g., a credit score, such as a FICO® score) falls. The credit bureau 106 may compare the derived data 130 and the consumer data 122 with the criteria specified by the one or more scorecards 136 (corresponding to each of the one or more secondary lenders 110) to determine whether any offers to apply for financing are available.

At 312, a determination is made as to how many offers to apply for financing are provided by the one or more secondary lenders. If a determination is made that zero offers to apply for financing are provided by the one or more secondary lenders, at 312, then a consumer may be informed that the prequalification process has been completed (e.g., without the consumer receiving an invitation to apply for financing from a lender), at 314. For example, if the consumer data 122 and/or the derived data 120 do not satisfy the criteria in the scorecards 136, then the result 142 may indicate that the prequalification process has been completed (e.g., no offer to apply for financing is available from the secondary lenders 110).

If a determination is made that one offer to apply for financing has been provided by the one or more secondary lenders, at 312, then the offer to apply for financing from the secondary lender may be processed, at 316. For example, processing the offer to apply for financing may include retrieving a corresponding template, presenting the template to the consumer, and receiving the consumer's signature to create a signed disclosure. Processing an offer from a lender is described in more detail in FIG. 4 and FIG. 5.

If a determination is made that more than one offer to apply for financing has been provided by the one or more secondary lenders, at 312, then an arbitration algorithm (e.g., the arbitration algorithm 144 of FIG. 1) may be used to select one of the offers, at 318, and the selected offer may be processed, at 320. For example, processing the offer may include retrieving a corresponding template, presenting the template to the consumer, and having the consumer sign the completed template to create a signed disclosure. Processing an offer from a lender is described in more detail in FIG. 4 and FIG. 5.

Thus, while shopping at a retailer, a consumer may provide consumer data when filling in a prequalification template to apply to be prequalified for financing from at least one primary lender. The primary lender may determine a metric, such as a credit score (e.g., FICO® score). The primary lender may determine whether to provide the consumer an invitation to apply for financing based on the metric and the consumer data. If the primary lender declines to provide an invitation to apply for financing, the primary lender may provide data derived from the metric that identifies a range within which the metric falls. The derived data and the consumer data may be sent to a credit bureau and compared with scorecards of one or more secondary lenders to determine whether the consumer qualifies for one or more invitations to apply for financing (e.g., offers) from the secondary lenders. If the consumer qualifies for more than one invitation, an arbitration algorithm may be used to select one of the invitations from the secondary lender. In this way, if a primary lender declines to provide an invitation to apply for financing, a determination may be made whether the consumer qualifies for an invitation from a secondary lender. Thus, instead of the retailer losing a sale because the primary lender declined to provide an offer to apply for financing, the retailer can increase the number of sales (and satisfied consumers) by determining whether a secondary lender can invite the consumer to apply for financing.

If the primary lender or one of the secondary lenders provides an invitation to apply for financing, the disclosure system may retrieve a corresponding template and send it to the POS terminal to present the template to the consumer. At least some of the fields in the template may be prefilled based on the consumer data. In some cases, the consumer may provide additional consumer data because the lender associated with the template may request some consumer data that the primary lender did not request in the prequalification template.

FIG. 4 is a flow diagram of an example process 400 that includes receiving a template according to some implementations. For example, the process 400 may be performed by the POS terminal 102, the interface 118, or a combination of the POS terminal 102 and the interface 118 of FIG. 1 or FIG. 2.

At 402, a disclosure may be retrieved (or received). For example, in FIG. 2, the POS terminal 102 or the interface 118 may receive the disclosure 206 after a lender (e.g., the primary lender 108 or one of the secondary lenders 110) has been identified to provide an offer of financing. The disclosure 206 may be an application for financing from the lender. For example, in FIG. 2, the disclosure system 148 may automatically send the disclosure 206 to the POS terminal 102 when the result 142 (or the answer 128) of FIG. 1 indicates that an offer to apply for financing is available from a lender (e.g., the primary lender 108 or one of the secondary lenders 110).

At 404, additional consumer data may be received to fill in the template. For example, the disclosure 206 may be displayed on the POS terminal 102 and may be at least partially prefilled using the consumer data 122 provided when filling in the prequalification template 121. If the disclosure 206 requests information that was not previously included in the consumer data 122, the consumer 120 (or an agent of the retailer 114) may provide additional consumer data to complete filling in the disclosure 206.

At 406, signature data may be created. For example, in FIG. 2 a signature touch pad (or other input device) that is electronically coupled to the POS terminal 102 may be used to receive stylus input from the consumer 120 to create the signature data. As another example, the template, with the fields filled in using data provided by the consumer, may be printed, the consumer may initial at least some of the printed pages and sign one of the printed pages, and digital image data of at least a portion of the initialed and signed printed document may be obtained to create the signature data. The digital image data may be obtained by scanning, faxing, photographing etc. the initialed and signed printed document. The signature data may be created based on the digital image data.

At 408, the disclosure, the additional consumer data (e.g., used to fill in the template), and the signature data may be sent. For example, in FIG. 2, the POS terminal 102 or the interface 118 may send the name-value pairs 208 (e.g., the disclosure 206 plus the additional consumer data used to fill in the disclosure 206) and the signature data 210 to the disclosure system 148.

Thus, when a lender has prequalified a consumer based on consumer data provided via a prequalification template, a disclosure (e.g., application for financing) corresponding to the lender and the retailer may be provided to the consumer. At least some of the fields of the template may be prefilled using the consumer data. In some cases, the consumer may provide additional consumer data to fill in the fields of the disclosure. The consumer may sign the disclosure to create a signed disclosure. Signature data corresponding to the signature may be created. The disclosure and the signature data may be sent to the disclosure system. Templates may be associated with one or more of (1) the lender making the offer, (2) the retailer associated with the transaction, or (3) one or more characteristics (e.g., active military, ex-military, non-military, etc.) of the consumer. By using electronic templates, a retailer may avoid having to keep on hand multiple paper applications for multiple lenders. Lenders can create templates ahead of time for various retailers, for various types of consumers, and for various types of offers and the appropriate template can be selected from among the previously made templates after an offer is selected to be presented to the consumer.

FIG. 5 is a flow diagram of an example process 500 that includes creating a disclosure according to some implementations. For example, the process 500 may be performed by the disclosure system 148 of FIG. 1 or FIG. 2.

At 502, a disclosure, additional consumer data, and signature data may be received. For example, in FIG. 2, the disclosure system 148 may receive the name-value pairs 208 (e.g., the disclosure 206 with the fields filled in with the additional consumer data) and the signature data 210 from the POS terminal 102 or the interface 118.

At 504, an attachment identifier may be obtained for each attachment. At 506, the disclosure may be modified to include the additional consumer data and the signature data. For example, in FIG. 2, the disclosure system 148 may create the disclosure 206 and associate the disclosure identifier 214 (e.g., a UUID) with the disclosure 206. If there are attachments (e.g., the signature data 210) associated with the disclosure 206, each of the attachments 220 to 222 may be associated with a corresponding identifier 224 to 226 and attached to (e.g., included in) the disclosure 206.

At 508, a digital signature may be created (e.g., using a cryptographic hash function). For example, in FIG. 2, the cryptographic hash function 228 may be used to create the DSIG 230 using the disclosure 206 as input. The DSIG 230 may be used to reference the signed disclosure as a legally binding document to verify the authenticity of the signed disclosure.

Thus, a disclosure system may receive signature data along with name-value pairs corresponding to a disclosure that has been filled in and create and save an electronic disclosure that includes the template used to create the disclosure, the name-value pairs, and the signature data. The disclosure system may assign a unique identifier (e.g., UUID) to the disclosure and create a digital signature that may be used to securely reference the signed disclosure.

### Example Computing Device and Environment

FIG. 6 illustrates an example configuration of a computing device 600 and environment that can be used to implement the modules and functions described herein. For example, the POS terminal 102, the server 104, or the disclosure system 148 may include an architecture that is similar to or based on the computing device 600.

The computing device 600 may include one or more processors 602, a memory 604, communication interfaces 606, a display device 608, other input/output (I/O) devices 610, and one or more mass storage devices 612, able to communicate with each other, such as via a system bus 614 or other suitable connection. The I/O devices 610 may include a keyboard, a mouse, a touchscreen display, a touch-sensitive pad and stylus, a camera, a scanner, a fax machine, etc.

The processor 602 may be a single processing unit or a number of processing units, all of which may include single or multiple computing units or multiple cores. The processor 602 may be implemented as one or more microprocessors, microcomputers, microcontrollers, digital signal processors, central processing units, state machines, logic circuitries, and/or any devices that manipulate signals based on operational instructions. Among other capabilities, the processor 602 may be configured to fetch and execute computer-readable instructions stored in the memory 604, mass storage devices 612, or other computer-readable media.

Memory 604 and mass storage devices 612 are examples of computer storage media for storing instructions, which are executed by the processor 602 to perform the various functions described above. For example, memory 604 may generally include both volatile memory and non-volatile memory (e.g., RAM, ROM, or the like). Further, mass storage devices 612 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein, and may be capable of storing computer-readable, processor-executable program instructions as computer program code that can be executed by the processor 602 as a particular machine configured for carrying out the operations and functions described in the implementations herein.

Computer storage media includes non-transitory media, such as non-volatile, removable and non-removable media implemented in any method or technology for storage of information, such as computer readable instructions, data structures, program modules, or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave. As defined herein, computer storage media does not include communication media.

The computing device 600 may also include one or more communication interfaces 606 for exchanging data with other devices, such as via a network, direct connection, or the like, as discussed above. The communication interfaces 606 can facilitate communications within a wide variety of networks and protocol types, including wired networks (e.g., LAN, cable, etc.) and wireless networks (e.g., WLAN, cellular, satellite, etc.), the Internet and the like. Communication interfaces 606 can also provide communication with external storage (not shown), such as in a storage array, network attached storage, storage area network, or the like.

A display device 608, such as a monitor may be included in some implementations for displaying information and images to users. Other I/O devices 610 may be devices that receive various inputs from a user and provide various outputs to the user, and may include a keyboard, a remote controller, a mouse, a printer, audio input/output devices, voice input, and so forth.

Memory 604 may include modules and components for creating disclosures and related documents according to the implementations described herein. The memory 604 may include multiple software applications, e.g., the applications 616 to 618, to perform various functions. For example, when the computing device 600 is used to implement the POS terminal 102, the software application 116 may comprise one of the applications 616 to 618. When the computing device 600 is used to implement the server 104, the cryptographic hash function 228 may comprise one of the applications 616 to 618. When the computing device 600 is used to implement the disclosure system 148, the software application 116 may comprise one of the applications 616 to 618. The memory 604 may also include other modules 620 that implement other features and other data 620 that includes intermediate calculations and the like. The other modules 616 may include various software, such as an operating system, drivers, communication software, or the like.

Although illustrated in FIG. 6 as being stored in memory 604 of computing device 600, the applications 616 to 618, other modules 620, and other data 622, or portions thereof, may be implemented using any form of computer-readable media that is accessible by the computing device 600. As used herein, “computer-readable media” includes non-transitory media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

FIG. 7 is a block diagram that illustrates an example of attaching additional attachments to a disclosure and is generally designated 700. After a consumer provides consumer data and in some cases additional consumer data, the consumer may sign the disclosure and the signature may be captured electronically. After the consumer's signature (e.g., signature data 210) has been obtained, the disclosure may be become unalterable and a digital signature may be created based on the disclosure and the signature data. For example, the disclosure 206 may be created and filled in by the consumer. The consumer's signature may be captured, the signature data may be attached to the disclosure 206 as the first attachment 702, and the document 206 and the first attachment 702 may be made unalterable. A first digital signature 704 may be created to verify that the disclosure 206 and the first attachment 702 have not been altered.

In some situations, additional attachments may be added to the disclosure 206. For example, the lender may modify one or more of the terms and conditions of the disclosure 206. The modification may be caused due to a change in Federal or state laws, business conditions, or other conditions. As another example, the circumstances of the consumer who signed the disclosure 206 may change (e.g., due to marriage, job loss, pay cut, or other major change) and a co-signer or guarantor may be added to the financing arrangement described by the disclosure 206. Because the disclosure 206, the first attachment 702, and the first digital signature 704 are unalterable, additional attachments may be added to the disclosure 206, the first attachment 702, and the first digital signature 704, and the resulting combination may be made unalterable. For example, a second attachment 706 and a third attachment 708 may be added to the disclosure 206, the first attachment 702, and the first digital signature 704 and the collection that includes 206, 702, 704, 706, and 708 may be made unalterable. To illustrate, the second attachment 706 may include modifications to the terms and conditions of the disclosure 206, and the third attachment 708 may include second signature data (e.g., another signature from the consumer) to acknowledge that the consumer has agreed to the modified terms and conditions included in the second attachment 706. A second digital signature 710 may be created based on the 206, 702, 704, 706, and 708 to verify that the 206, 702, 704, 706, and 708 are unaltered.

A similar process, in which an additional one or more attachments are added and another digital signature is created, may be repeated each time attachments are added to the disclosure 206. For example, a fourth attachment 712 may be added and the collection of 206, 702, 704, 706, 708, 710, and 712 may be made unalterable. To verify that the collection of 206, 702, 704, 706, 708, 710, and 712 is unaltered, a third digital signature 714 may be created.

Each of the attachments 702, 706, 708, and 712 may be assigned a corresponding identifier, such as a UUID. For example, the disclosure 206 may be assigned the disclosure identifier 214. of FIG. 2. The first attachment 702 may be assigned the first identifier 224. The first digital signature 704 may be created using a cryptographic hash function that takes 206, 214, 702, and 224 as input. Similarly, the second digital signature 710 may be calculated using 206, 214, 702, 224, 706, a second identifier (e.g., UUID) assigned to 706, 708, and a third identifier assigned to 708. The third digital signature 714 may be calculated similarly, including a fourth identifier assigned to the fourth attachment 712.

Thus, though the disclosure 206 is unalterable (e.g., no additions, deletions, or modifications may be made to the contents of the disclosure 206), attachments may be added to the disclosure 206. The attachments may include one or more of terms, conditions, or an additional signature. For example, an attachment may include terms and conditions that serve to replace the terms and conditions of the disclosure 206. Because the disclosure 206 is unalterable, the new terms and conditions may be added as an attachment with language indicating that the new terms and conditions replace the terms and conditions from the disclosure 206. The disclosure 206, along with the attachment that includes the new terms and conditions, may become unalterable and a new digital signature may be created. Thus, each time one or more attachments are added to a disclosure, the disclosure and any previous attachments, along with any previous digital signatures, may be made unalterable and a new digital signature may be created. The new digital signature may be used to verify that the disclosure, any previous attachments, and any previous digital signatures are unaltered.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A method performed by one or more processors executing instructions to perform acts comprising:
receiving, by a disclosure system, name-value pairs, names of the name-value pairs comprising fields of a template and values of the name-value pairs comprising consumer data associated with a consumer;
receiving, by the disclosure system, signature data including a signature of the consumer;
creating a disclosure that includes the name-value pairs and the signature data;
associating a universally unique identifier with the disclosure; and
creating a digital signature by providing the disclosure as input to a cryptographic hash function, the digital signature corresponding to the disclosure.

2. The method as recited in claim 1, wherein the template is associated with both a lender and a retailer.

3. The method as recited in claim 1, wherein the disclosure comprises a legally binding financing application between the consumer and a lender.

4. The method as recited in claim 1, wherein the disclosure is compliant with both the Fair Credit Reporting Act and the Truth in Lending Act.

5. The method as recited in claim 1, wherein creating the disclosure that includes the name-value pairs and the signature data comprises:
adding the signature data to the disclosure as an attachment; and
associating a second universally unique identifier with the attachment.

6. The method as recited in claim 1, the acts further comprising:
recreating a signed disclosure based on the digital signature.

7. A disclosure system comprising:
one or more processors;
one or more computer-readable storage media storing instructions executable by the one or more processors to perform acts comprising:
receiving a template and values used to fill in fields of the template, the values comprising consumer information associated with a consumer;
receiving signature data including a signature of the consumer;
creating a disclosure that includes the template, the values, and the signature data;
associating a universally unique identifier with the disclosure; and
creating, using a cryptographic hash function, a digital signature that corresponds to the disclosure.

8. The computing device as recited in claim 7, wherein the template includes a timestamp indicating one of when the template was created or when the template was sent to obtain the values.

9. The computing device as recited in claim 7, wherein the template is provided by a lender for use with a retailer.

10. The computing device as recited in claim 7, wherein the disclosure enables the consumer to make a purchase at a retailer for one or more goods or services.

11. The computing device as recited in claim 7, wherein the signature data comprises an image of a signature of the consumer on a printed page.

12. The computing device as recited in claim 7, wherein the signature data comprises data received from a touch-sensitive pad that is written on by the consumer using a stylus.

13. One of more computer-readable storage media including instructions that are executable by one or more processors to perform acts comprising:
receiving names and values, the names comprising fields of a template and the values comprising consumer data associated with a consumer;
receiving signature data comprising a signature of the consumer;
creating a disclosure that includes the names, the values, and the signature data;
associating a universally unique identifier with the disclosure; and
creating a digital signature of the disclosure using a cryptographic hash function, the digital signature representing the disclosure with the signature data.

14. The one of more computer-readable storage media as recited in claim 13, the template comprising terms and conditions of an offer of financing to the consumer.

15. The one of more computer-readable storage media as recited in claim 13, wherein the template is associated with a universally unique identifier that identifies the template from other templates stored in the one or more computer-readable storage media.

16. The one of more computer-readable storage media as recited in claim 13, wherein the signature comprises digital image data associated with a signature on at least a portion of the template that was printed.

17. The one of more computer-readable storage media as recited in claim 13, wherein the template is selected based on at least one of a lender providing an offer of financing to the consumer, a retailer where the offer of financing is to be used, or a characteristic of the consumer.

18. The one of more computer-readable storage media as recited in claim 13, the acts further comprising:
storing the disclosure in the one of more computer-readable storage media; and
referencing the disclosure using the digital signature.

19. The one of more computer-readable storage media as recited in claim 13, wherein:
the disclosure includes one or more attachments; and
the one or more attachments include the signature data.

20. The one of more computer-readable storage media as recited in claim 13, the acts further comprising:
verifying the legality of the disclosure using the digital signature.
